(19) United States
(12) Patent Application Publication
(10) Pub. No.: US 2020/0099414 A1
(43) Pub. Date: Mar. 26, 2020

(54) WATERPROOF SMARTPHONE CASE WITH LENS

(71) Applicant: CRAIG HERMAN, BURLINGTON (CA)

(72) Inventor: CRAIG HERMAN, BURLINGTON (CA)

(21) Appl. No.: 16/510,553

(22) Filed: Jul. 12, 2019

Related U.S. Application Data
(60) Provisional application No. 62/670,977, filed on May 14, 2018.

(51) Int. Cl. H04B 1/3888; A45C 11/00; A45C 15/00

(52) U.S. Cl. CPC H04B 1/3888; A45C 11/00; H04B 2001/3894; A45C 2011/002; A45C 15/00

(57) ABSTRACT

A waterproof smartphone case with lens with a case body having a back, an internal lens track, a first gasket, an open front, an open top, and a hinged door. The hinged door has a hinge, a second gasket, a selectively engageable latch mechanism, a closed position, and an alternate open position. The second gasket and the latch mechanism are configured to make a watertight seal between the hinged door and the case body. There is a removable lens, wherein the removable lens is slidable along the internal lens track of the case body. The removable lens and the first gasket are configured to make a watertight seal around the open front and thus make the case entirely waterproof. A variety of lenses can be used and easily interchanged, such as a transparent lens, magnifying lenses of varying strengths, prescription lenses, anti-glare lenses, and privacy lenses.

### BACKGROUND OF THE INVENTION

Various types of smartphone screen magnifiers are known; however, few are integrated directly into a case. Most existing screen magnifiers are either external attachments, or adhere directly to the phone. External attachments are cumbersome, easily breakable, and are often not present when needed. For those screen magnifiers that adhere directly to the phone, they are typically not easily removable or interchangeable, and may limit the use of a protective case. Of the smartphone screen magnifiers that are integrated directly into a case, the cases offer less protection than may be desired and are not waterproof. What is needed, and what the present waterproof smartphone case with lens provides, is a waterproof, protective case with a lens that is easily interchangeable. The present waterproof smartphone case with lens allows a user to have the maximum protection afforded by a case while providing the option to use a traditional lens, magnifying lens, or prescription lens so as to eliminate the need for a user to wear glasses.

### FIELD OF THE INVENTION

The present invention relates to screen magnifiers, and more particularly, to a waterproof smartphone case with lens.

### SUMMARY OF THE INVENTION

The general purpose of the present waterproof smartphone case with lens, described subsequently in greater detail, is to provide a waterproof smartphone case with lens that has many novel features that result in a waterproof smartphone case with lens that is not anticipated, rendered obvious, suggested, or even implied by prior art, either alone or in combination thereof.

To accomplish this, the present waterproof smartphone case with lens includes a case body having a back, an internal lens track, a first gasket, an open front, an open top, and a hinged door. The hinged door has a hinge, a second gasket, a selectively engageable latch mechanism, a closed position, and an alternate open position. The hinge is disposed on an edge of the open top, and the second gasket is disposed around the edge of the open top or, in an alternative embodiment, around a second edge of the hinged door. The second gasket and the latch mechanism are configured to make a watertight seal between the hinged door and the case body when the hinged door is in the closed position. There is a removable lens, and the removable lens is slidable along the internal lens track of the case body. The internal lens track is proximal the open front, allowing the removable lens and the first gasket to be configured to make a second watertight seal around the open front, and thus make the waterproof smartphone case with lens entirely waterproof. A variety of lenses can be used and easily interchanged by merely disengaging the latch mechanism, opening the hinged door to the alternate open position, sliding out a current lens, sliding in a new lens, returning the hinged door to the closed position, and re-engaging the latch mechanism. Lens options include a transparent lens with no special optical qualities, magnifying lenses of varying strengths, prescription lenses, anti-glare lenses, and privacy lenses. All lens options are of a conductive material so as to maintain touchscreen functionality for the smartphone.

Thus have been broadly outlined the more important features of the present waterproof smartphone case with lens so that the detailed description thereof that follows may be better understood and in order that the present contribution to the art may be better appreciated.

### BRIEF DESCRIPTION OF THE DRAWINGS

### Figures

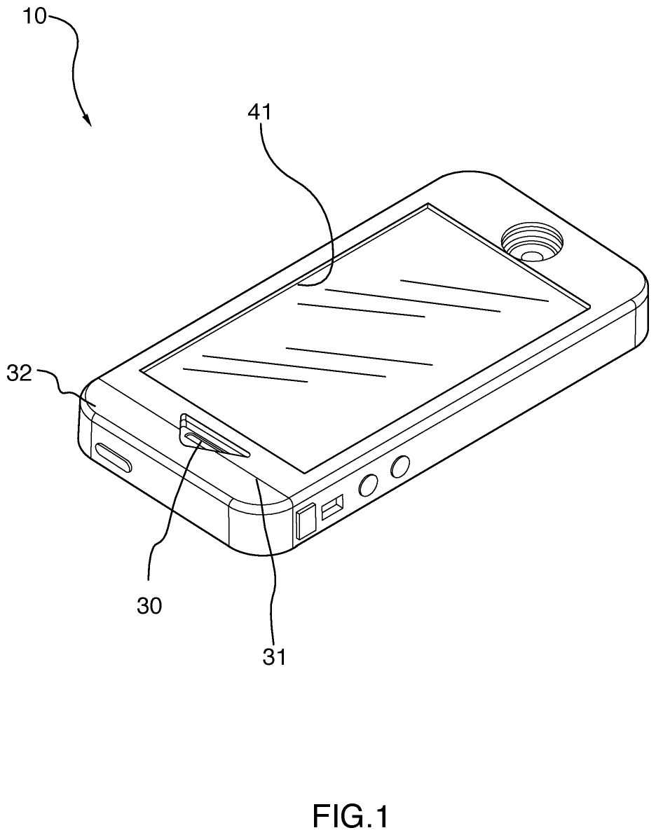

FIG. 1 is an isometric view of a waterproof smartphone case with lens.

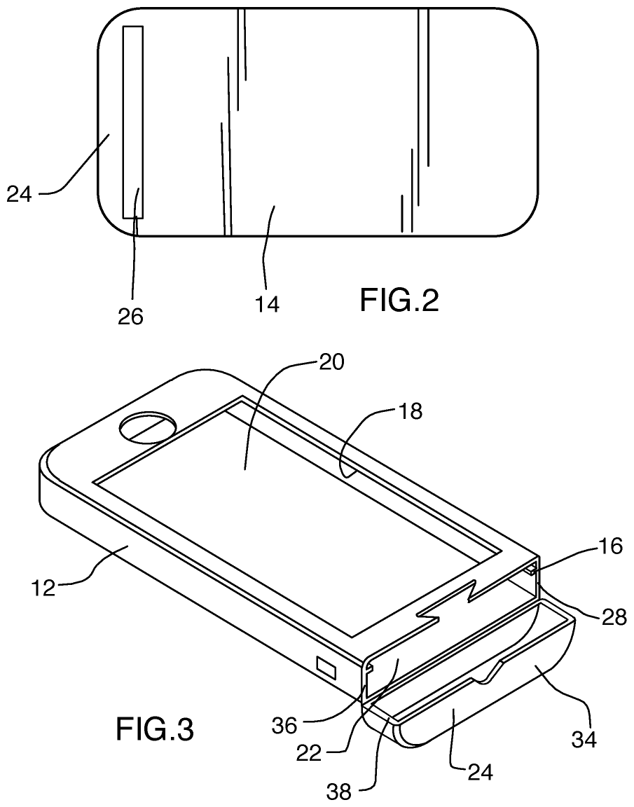

FIG. 2 is a bottom plan view of the waterproof smartphone case with lens.

FIG. 3 is an isometric view of the waterproof smartphone case with lens with the hinged door in the open position.

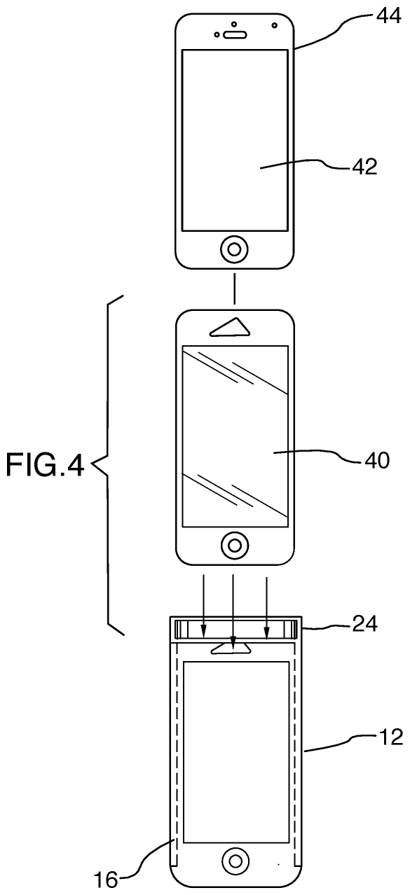

FIG. 4 is an exploded top plan view showing a smartphone and the waterproof smartphone case with lens.

### DETAILED DESCRIPTION OF THE DRAWINGS

With reference now to the drawings, and in particular FIGS. 1 through 4 thereof, an example of the instant waterproof smartphone case with lens employing the principles and concepts of the present waterproof smartphone case with lens and generally designated by the reference number 10 will be described.

Referring to FIGS. 1 through 4 the present the waterproof smartphone case with lens 10 is illustrated. The waterproof smartphone case with lens 10 includes a case body 12 having a back 14, an internal lens track 16, a first gasket 18, an open front 20, an open top 22, and a hinged door 24. The hinged door 24 has a hinge 26, a second gasket 28, a selectively engageable latch mechanism 30, a closed position 32, and an alternate open position 34. The hinge 26 is disposed on an edge 36 of the open top 22, and the second gasket 28 is disposed around the edge 36 of the open top or, in an alternative embodiment, around a second edge 38 of the hinged door. The second gasket 28 and the latch mechanism 30 are configured to make a watertight seal 31 between the hinged door 24 and the case body 12 when the hinged door is in the closed position 32. There is a removable lens 40, wherein the removable lens is slidable along the internal lens track 16 of the case body. The internal lens track 16 is proximal the open front 20, allowing the removable lens 40 and the first gasket 18 to be configured to make a second watertight seal 41 around the open front and thus make the waterproof smartphone case with lens 10 entirely waterproof. A variety of lenses can be used and easily interchanged by merely disengaging the latch mechanism 30, opening the hinged door 24 to the alternate open position 34, sliding out a current lens, sliding in a new lens, returning the hinged door to the closed position 32, and re-engaging the latch mechanism 30. The removable lens 40 can have an optical effect on a screen 42 of a smartphone 44.

What is claimed is:

1. A waterproof smartphone case with lens comprising:
a case body having a back, an internal lens track, a first gasket, an open front, an open top, and a hinged door, wherein the hinged door has a hinge, a second gasket, a selectively engageable latch mechanism, a closed position, and an alternate open position, wherein the hinge is disposed on an edge of the open top, wherein the second gasket and the latch mechanism ate configured to make a watertight seal between the hinged door and the case body when the hinged door is in the closed position; and
a removable lens, wherein the removable lens is slidable along the internal lens track of the case body, wherein the removable, lens and the first gasket are configured to make a second watertight seal around the open front.
